(19) United States
(12) Patent Application Publication
(10) Pub. No.: US 2009/0114461 A1
(43) Pub. Date: May 7, 2009

(54) Electric Brake Manual Release Mechanism

(75) Inventors: Warren W. Clark, Evans, GA (US); Landon N. Ball, North Augusta, SC (US)

Correspondence Address: HARNESS, DICKEY & PIERCE, P.L.C., P.O. BOX 828, BLOOMFIELD HILLS, MI, 48303, US

(73) Assignee: TEXTRON INC., Providence, RI (US)

(21) Appl. No.: 12/262,212

(22) Filed: Oct. 31, 2008

Related U.S. Application Data
(60) Provisional application No. 60/983,964, filed on Oct. 31, 2007.

(51) Int. Cl. F16D 65/14; B60L 7/00; B60K 1/00

(52) U.S. Cl. 180/65.1; 188/216; 188/161

(57) ABSTRACT

A manual release mechanism for an electric braking assembly is provided. In various implementations, the manual release mechanism includes a shaft having an armature retraction cap connected to a distal end of the shaft and a handle connected to a proximal end of the shaft. The shaft includes threads that are mateable with threads provided in a bore of a magnet body of the braking assembly. The shaft threads are formed along at least a portion of the shaft such that a small angular displacement of the handle will cause an axial translation of the shaft within the magnet body. The axial translation will move the retraction cap to exert force on an armature plate of the braking assembly. The force of the retraction cap on the armature plate disengages contact between the armature plate and a friction disk of the braking assembly allowing the friction disk to rotate freely.

### CROSS-REFERENCE TO RELATED APPLICATIONS

This application claims the benefit of U.S. Provisional Application No. 60/983,964 filed on Oct. 31, 2007. The disclosure of the above application is incorporated herein by reference.

### FIELD

The present teachings relate to braking systems for light-weight utility vehicles.

### BACKGROUND

The statements in this section merely provide background information related to the present disclosure and may not constitute prior art.

Many contemporary electric powered light-weight utility vehicles, such as maintenance vehicles, cargo vehicles, shuttle vehicles, personal vehicles, and golf cars include braking systems that utilize a mechanical braking assembly coupled to a shaft of the vehicle's electric motor. Generally, in such instances, the mechanical braking assembly applies reverse torque to the motor shaft to provide braking of the vehicle. More particularly, in at least some known applications, such mechanical braking assemblies require electrical power to energize one or more solenoids or coils of the assembly that disengage mechanical brakes of the assembly, thereby releasing or reducing the braking torque applied to the motor shaft. Thus, the controlled application of electrical power to the braking assembly causes the braking assembly to provide controlled braking torque to the motor, and hence, to the vehicle.

However, in the absence of electrical power to the braking assembly, the mechanical brakes will be fully actuated, and therefore, apply maximum braking to the vehicle. Thus, if the electrical power system, e.g., the vehicle battery bank, and/or the vehicle main controller, malfunction or are rendered inoperable such that electrical energy can not be provided to the braking assemblies, the braking assemblies will engage generating maximum braking torque until the operability of the electrical power system is restored. Accordingly, if the electrical power system fails, the vehicle can not be moved without damaging the vehicle. In such instances, the braking assembly can be manually disengaged to allow vehicle movement, or the vehicle power train can be physically lifted to allow the vehicle to be towed.

### SUMMARY

In accordance with various embodiments of the present disclosure, a manual release mechanism for an electric braking assembly is provides. In accordance with various implementations, the manual release mechanism includes a shaft having an armature retraction cap connected to a distal end of the shaft and a handle connected to a proximal end 114 of the shaft. The shaft includes threads that are mateable with threads provided in a bore of a magnet body of the braking assembly. The shaft threads are formed along at least a portion of the shaft such that a small angular displacement of the handle will cause an axial translation of the shaft within the magnet body. The axial translation will move the retraction cap to exert force on an armature plate of the braking assembly. The force of the retraction cap on the armature plate disengages contact between the armature plate and a friction disk of the braking assembly allowing the friction disk to rotate freely.

Further areas of applicability of the present teachings will become apparent from the description provided herein. It should be understood that the description and specific examples are intended for purposes of illustration only and are not intended to limit the scope of the present teachings.

### DRAWINGS

The drawings described herein are for illustration purposes only and are not intended to limit the scope of the present teachings in any way.

FIG. 1 is a side view of an electric vehicle including an electric braking assembly having a manual brake release mechanism, in accordance with various embodiments of the present disclosure.

FIG. 2 is an isometric view of a gear reduction assembly coupled to a vehicle prime mover and the braking assembly show in FIG. 1, in accordance with various embodiments of the present disclosure.

FIG. 3 is a cross-sectional view of the braking assembly including the manual brake release mechanism, shown in FIG. 1, in accordance with various embodiments of the present disclosure.

FIG. 4 is a cross-sectional view of the braking assembly including the manual brake release mechanism, shown in FIG. 1, in accordance, with various other embodiments of the present disclosure.

FIG. 5 is side view of a manual brake release mechanism, shown in FIGS. 1, 3 and 4, in accordance with various embodiments of the present disclosure.

### DETAILED DESCRIPTION

The following description is merely exemplary in nature and is in no way intended to limit the present teachings, application, or uses. Throughout this specification, like reference numerals will be used to refer to like elements.

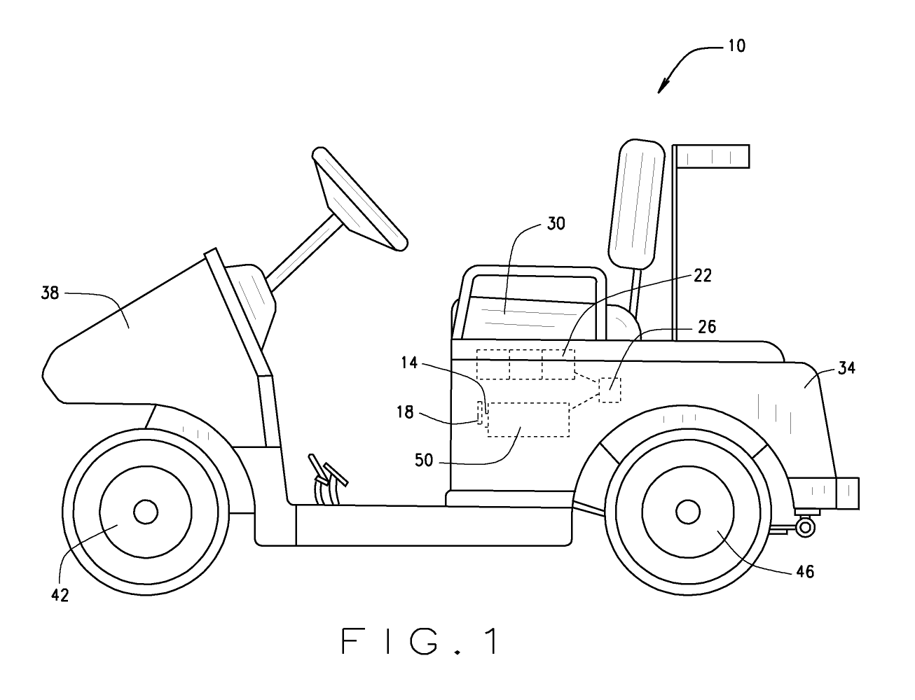

FIG. 1 illustrates a light-weight electric vehicle 10, such as a small cargo/maintenance vehicle, a shuttle/transport vehicle, a golf car, etc., including an electric braking assembly 14 having a manual brake release mechanism 18, in accordance with various embodiments of the present disclosure. The manual brake release mechanism 18 is structured and operable to release or disengage the braking assembly 14 if a vehicle 10 electrical power system, e.g., the vehicle battery bank, 22 and/or a vehicle main controller 26, malfunction or are rendered inoperable such that electrical energy can not be provided to release the braking assembly 14.

Additionally, the vehicle 10 can include at least one seat assembly 30 mounted to a rear body section 34, a front body section 38 and a pair of front wheels 42 and a pair of rear wheels 46. At least one of the rear wheels 46 is driven by a prime mover 50, e.g., an induction motor, that provides motive power for propelling the vehicle 10. The main controller 26 controls various operations of the vehicle 10. For example, the controller 26 can be communicatively connected to the motor 42 and the brake assembly 14 to control motive forces provided by the motor 50 and an amount of braking applied by the braking assembly 14 during a vehicle braking operation.

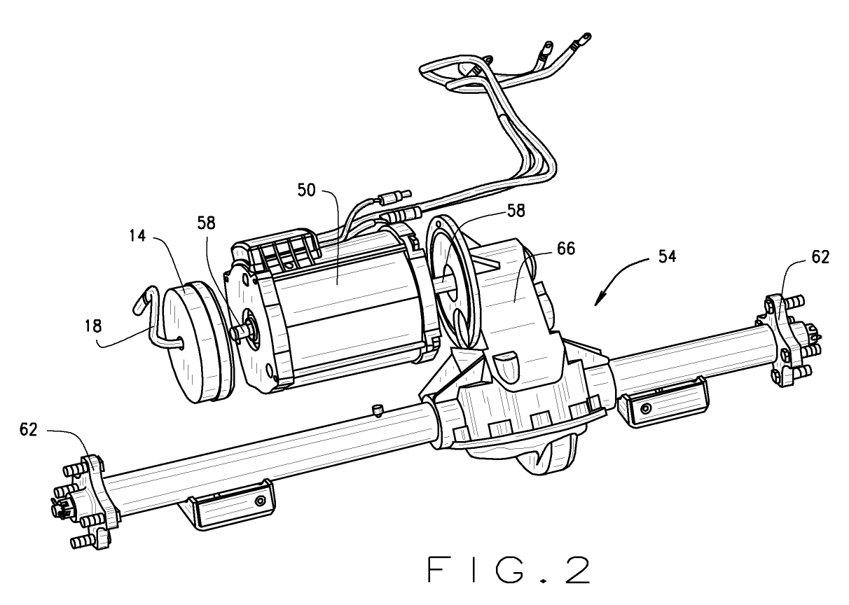

Referring now to FIG. 2, to deliver motive forces to the vehicle 10, the motor 50 is coupled to a gear reduction assembly 54 via motor shaft 58. The gear reduction assembly 54 reduces the rotational power provided by the motor 50 to torque delivered to rear wheel hubs 62 and the rear wheels 46 (shown in FIG. 1) mounted to the hubs 62, via gear reduction box 66, thereby providing propulsion to the vehicle 10. In various embodiments, the braking assembly 14 is coupled to the motor shaft 58 at an opposing end from where the gear reduction assembly 54 is coupled to the shaft 58. Generally, the main controller 26 controls the operation of the braking assembly 14 to apply frictional braking forces, i.e., braking torque, to slow and/or stop rotation of the motor shaft 58, and thereby slow and/or stop movement of the vehicle 10.

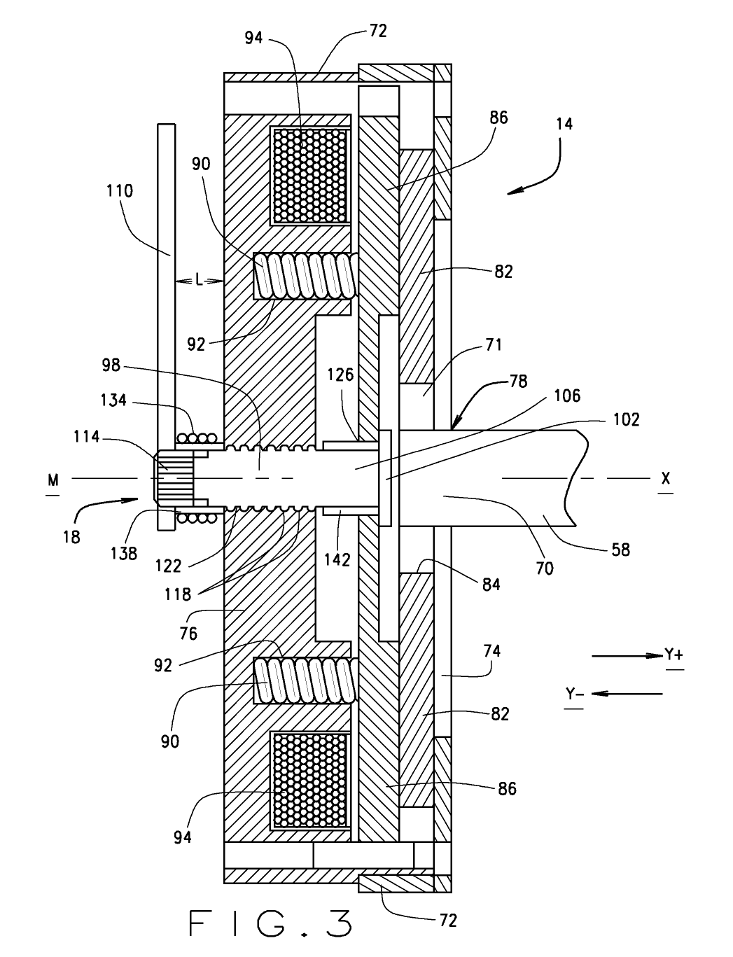

Referring now to FIG. 3, generally the brake assembly 14 is a cylindrical assembly coupled to the end portion 70 of the motor shaft 58 opposite the motor shaft end coupled to the gear reduction assembly 54 (shown in FIG. 2). The brake assembly 14 includes an outer shell 72 connected to an adapter plate 74 that provides a first outer wall of the brake assembly 14. A magnetic body 76 is also connected to the outer shell 74 providing an opposing second outer wall of the brake assembly 14. The outer adapter plate 74 includes a center aperture 78 through which the end portion 72 of the motor shaft 58 extends. A splined hub 71 is fixedly connected to the motor shaft end portion 70 and a friction disk 82 including a splined center aperture 84 is mounted on the splined hub 71 such that the friction disk 82 is radially, or laterally, fixed to the splined hub 71 but is axially, or longitudinally, movable on the splined hub 71. That is, the splined interconnection between the friction disk center aperture 84 and the splined hub 71 interconnects the motor shaft 58 and friction disk 82 such that the friction disk 82 will turn at the same revolutions per minute as the motor shaft 58 and prevent rotational slipping, i.e., radial or lateral slipping, of the friction disk 82 on the splined hub 71. However, the splined interconnection of the friction disk center aperture 84 and the splined hub 71 allow the friction disk 82 to longitudinally, or axially, move on the splined hub 71 along the shaft center axis X.

The brake assembly 14 additionally includes an armature plate 86 positioned between the friction disk 82 and the magnetic body 76. The brake assembly 14 further includes a plurality of compression springs 90 compressed within pockets 92 formed in magnetic body 76 by contact with the armature plate 86. During braking operations, i.e., scenarios wherein the braking assembly 14 is acting to slow or stop rotation of the motor shaft 58 and thus, the motor 50, the array of compression springs 90 exert uniform force in the Y⁺ direction on the armature plate 86 to press the armature plate against the friction disk 82. The force of the armature plate 86 against the friction disk 82 moves the friction disk 82 longitudinally, or axially, along the splined hub 71 connected to the motor shaft 58 in the Y⁺ direction. More particularly, the force of the armature plate 86 against the friction disk 82 compresses, or squeezes, the friction disk 82 between armature plate 86 and the adapter plate 74. Compressing the friction disk 82 between armature plate 86 and the adapter plate 74 generates braking torque to slow or stop rotation of the motor shaft 58 and motor 50.

As described above, the opposing end of the motor shaft 58 is coupled directly to the gear reduction assembly 54 to which the rear wheels 46 are mounted. Thus, compression of the friction disk 82 between armature plate 86 and the adapter plate 74 will slow or stop movement of the vehicle 10. In a static state, i.e., power to the vehicle has been disabled or turned ‘Off’, the compression springs 90 apply full force to the armature plate 86 to park, or lock, the motor 50 and rear wheels 46, thereby preventing movement of the vehicle 10

The adapter and armature plates 74 and 86 can be fabricated from any material having suitable rigidity, durability and frictional coefficient properties. For example, in various embodiments, one or both of the adapter and armature plates 74 and 86 can be fabricated of steel or cast iron. Additionally, the friction disk 82 can be fabricated of any material having a suitably high coefficient of friction. For example, in various embodiments, the friction disk 82 can be fabricated from a metal and fiberglass composite material, a sintered material, a ceramic material or a solid metal.

To release the braking assembly 14, i.e., remove or lessen the forces of the array of compression springs 90 compressing the friction plate 82 between the adapter and armature plates 74 and 86, the brake assembly 14 includes a plurality of electro-magnetic coils 94. A current through the coils 94, controlled by the controller 26, generates a magnetic field that attracts the armature plate 86, i.e., applies a force to the armature plate 86 in the Y⁻ direction. During a vehicle braking operation, the controller 26 controls the current through the coils 94 to generate a magnetic field. The generated magnetic field will exert attractive forces on the armature plate 86 in the Y⁻ direction. The generated forces in the Y⁻ direction are sufficient to overcome the forces on the armature plate 86 in the Y⁺ direction exerted by the springs 90. More particularly, current through the coils 94 can be controlled to lessen or remove frictional forces between the friction disk 82 and the adapter and armature plates 74 and 86, thereby controlling the braking forces on the motor shaft 58 and rear wheels 46.

Although the vehicle 10 is described and illustrated herein as being a rear wheel drive vehicle, such that the motor 50 provides motive and braking forces to the rear wheels 46, it should be understood that the vehicle 10 could be a front wheel drive vehicle, such that the motor 50 provides motive and braking forces to the front wheels 42, and remain within the scope of the invention.

If power to the vehicle 10 should be disabled or turned ‘Off’, the current through the coils 94 would be removed and the compression springs 90 would fully engage the adapter and armature plates 74 and 86 with the friction disk 82. To manually release engagement of the adapter and armature plates 74 and 86 with the friction disk 82 when vehicle power is disabled or turned ‘Off’, in various embodiments, the brake assembly includes the brake release mechanism 18.

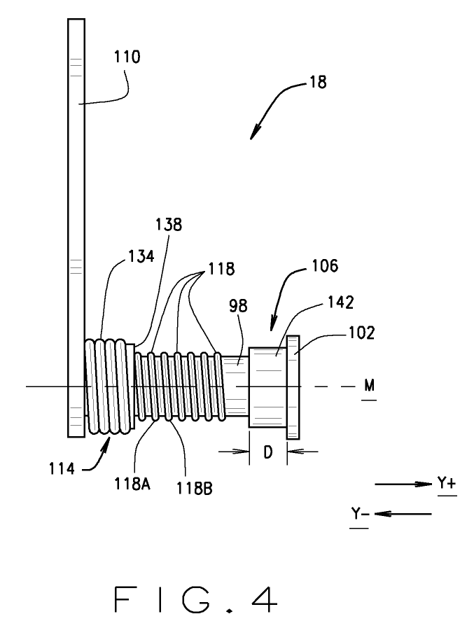

Referring now to FIGS. 3 and 4, in various embodiments, the brake release mechanism 18 includes a shaft 98 having an armature retraction cap 102 connected to a distal end 106 of the shaft 98. In various implementations, the retraction cap 102 is a plate having any suitable shape that can be connected to the distal 106 end in any suitable manner. For example, in various embodiments, the retraction cap 102 can be a circular plate, or disk, integrally formed with shaft 98 at the distal end 106. Alternatively, the retraction cap can be a square, oval, rectangular, etc., plate that is screwed, welded, bolted, glued, etc. to the shaft distal end 106. The brake release mechanism 18 can additionally include a handle 110 connected to an opposing proximal end 114 of the shaft 98. Furthermore, in various implementations, the braking mechanism 18 includes threads 118 formed along at least a portion of the shaft 98. More specifically, brake release mechanism shaft 98 extends through a threaded aperture 122 in the magnetic body 76 such that the threads 118 mate with and engage the threaded aperture 122. Therefore, angular rotation, or displacement, of the handle 110 about a center axis M of the brake release mechanism shaft 98 will axially, or linearly, move the shaft 98 along the M axis in the Y⁺ and Y⁻ directions, depending on the direction of angular rotation of the handle 110.

Additionally, the distal end 106 of the shaft 98 extends through a center aperture 126 in the armature plate 86 and includes a retraction cap 102 fixedly connected to the distal end 106. The retraction cap 102 has an outside diameter, or dimension, that is greater than the inside diameter of the armature plate aperture 126 and is fixedly connected to the distal end 106 on a ‘motor-side’ of the armature plate 86, i.e., the side of the armature plate facing the motor 50. Accordingly, movement of the release mechanism shaft 98 in the Y⁻ direction will cause the retraction cap 102 to retract the armature plate away from the friction disk 82, in the Y⁻ direction. More specifically, angular rotation, or displacement, of the handle 110 in a first angular direction will rotate the threads 118 within the threaded magnetic body aperture 122 causing the shaft 98 to linearly move along the M axis in the Y⁻ direction. Movement of the shaft 98 in the Y⁻ direction will move the retraction cap 102 in the Y⁻ direction causing the retraction cap 102 to apply force in the Y⁻ direction to the armature plate 86. Sufficient angular force applied to the handle 110 in the first angular direction will cause the force applied to the armature plate 86 in the Y⁻ direction by the retraction cap 102 to overcome the force on the armature plate 86 in the Y⁺ direction. Accordingly, sufficient angular force applied to the handle 110 in the first angular direction will release, or disengage, the brake mechanism such that the motor 50 can turn freely. That is, sufficient angular force applied to the handle 110 in first angular direction will cause the retraction cap 102 to retract the armature plate 86 away from the friction disk 82, allowing the friction disk 82 and motor shaft 58 to turn freely.

In various embodiments, the threads 118 have high angular pitch such that a small amount of rotation of the release mechanism shaft 98 will generate a large amount of linear movement of the shaft 98 along the M axis. More particularly, in various implementations, a small angular displacement of the handle 110 in the first angular direction, e.g., 5° to 10°, will linearly displace the shaft 98 and retraction cap 102 a sufficient amount to completely disengage, or release, the compressive force on the friction disk 82 by adapter and armature plates 74 and 86, as described above.

In various implementations the release mechanism shaft threads 118 comprise two or more independent threads, e.g., threads 118A and 118B (shown in FIG. 4), helically formed along the shaft 98. The two or more independent threads 118 will generate a large amount of linear displacement along the M axis with a small amount of angular displacement of the handle 110, e.g., 5° to 10°. The two or more independent threads 118 will also distribute the stresses generated during operation of the manual brake release mechanism 18, as described herein, among the two or more threads 118, thereby reducing the friction encountered by each thread 118.

In various embodiments, the brake release mechanism 18 further includes a torsion spring 134 mounted around the proximal end 114 of the shaft 98 between the handle 110 and the magnetic body 76. The torsion spring 134 is connected to the handle 110 and/or shaft 98 in such a manner that it will provide an angular force on the handle in a second angular direction opposite the first angular direction. Thus, the torsion spring 134 provides angular force to the handle 110 that will result in linear movement of the release mechanism shaft 98 along the M axis in the Y⁺ direction, thereby engaging the adapter and armature plates 74 and 86 with the friction disk 82.

Additionally, in various implementations, the brake release mechanism 18 further includes a first stop sleeve 138 positioned around the shaft proximal end 114 between the torsion spring 134 and the shaft 98. The first stop sleeve 138 has a length L such that angular movement of the handle 110 in the second angular direction, and thus, axial movement of the shaft 98 in the Y⁺ direction, is limited. That is, as the torsion spring 134 moves the handle 110 in the second angular direction, the first stop sleeve 138 will limit axial movement, or travel, of the shaft 98 in the Y⁺ direction and angular movement, or rotation, of the handle in the second angular direction to a particular position, referred to herein as the idle position. Thus, the force of the torsion spring 134 and the length L of the first stop sleeve 138 will return the handle 110 to the idle position after the brake release mechanism 18 has been utilized to disengage the brake assembly 14, as described above.

In various embodiments, the threads 118 are non-locking threads that have a very low coefficient of friction between the threads 118 and the magnetic body threaded aperture 122. Therefore, the force of the torsion spring 134 alone will return the handle 110 and shaft 98 to the idle position. That is, the handle 110 and shaft 98 will automatically self-return to the idle position, without manual assistance by a vehicle operator, wherein the friction disk 82 is compressed between the adapter and armature plates 74 and 86.

In various embodiments, the brake release mechanism 18 can further include a second stop sleeve 142 positioned around the shaft distal end 106 between the retraction cap 102 and the shaft threads 118. Accordingly, in such embodiments, the armature aperture 126 is sized to accommodate the second stop sleeve 142 such that the stop sleeve 142 can contact the retraction cap 102, as illustrated in FIG. 3. The second stop sleeve has a length D such that angular movement of the handle 110 in the first angular direction, and thus, the shaft 98 in the Y⁻ direction, is limited. That is, as the handle 110 is moved in the first angular direction, the first stop sleeve 138 will limit axial movement, or travel, of the shaft 98 in the Y⁻ direction and angular movement, or rotation, of the handle in the first angular direction to a particular position, referred to herein as the disengaged position. More particularly, as the handle 110 is moved in the first angular direction, e.g., the handle 110 is moved in the first angular direction by a vehicle operator, the shaft 98, retraction cap 102, second stop sleeve 142 and armature plate 86 will axially move, or travel, in the Y⁻ direction. After a predetermined amount of axial travel in the Y⁻ direction, the second stop sleeve 142 will contact the ‘motor-side’ of the magnetic body 76 and be bound between the magnetic body 76 and the retraction cap 102. Thus, the second stop sleeve 142 will limit axial travel, or displacement, in the Y⁻ direction of the shaft 98, retraction cap 102 and armature plate 86.

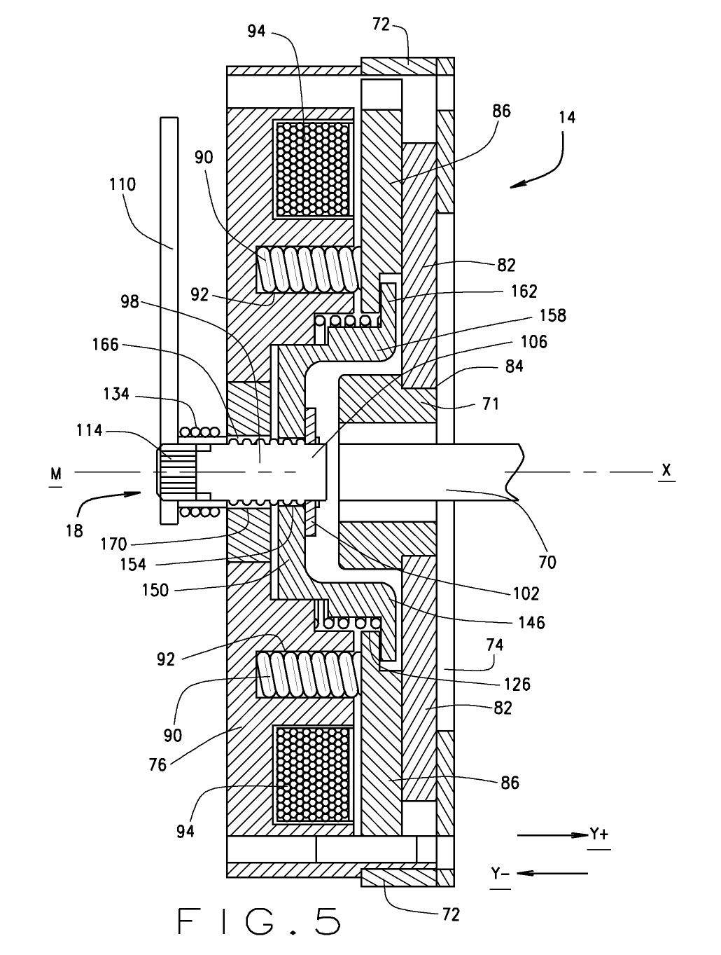

Referring now to FIG. 5, in various embodiments, the brake release mechanism 18 can include a flanged annular cup 146 positioned near the distal end 106 of the shaft 98 between the retraction cap 102 and the motor-side of the magnetic body 76. The flanged annular cup 146 generally includes an annular base portion 150 having a shaft aperture 154 through which the shaft 98 extends, a cylindrical wall portion 158 and a flanged, or winged, top portion 162 extending substantially orthogonally from the wall 158. The top flange 162 extends beyond the armature plate aperture 126 on the motor-side of the armature plate 86. Therefore, angular displacement of the handle 110 in the first angular direction will cause the retraction cap 110 to axially travel in the Y⁻ direction, as described above. Travel of the retraction cap 110 in the Y⁻ direction will and exert force on the base portion 150 flanged annular cup 146 causing the flanged annular cup to axially travel in the Y⁻ direction. As the flanged annular cup 156 axially moves in the Y⁻ direction, the top flange 162 will exert a force on the an armature plate 86 causing the armature plate to 86 to axially travel in the Y⁻ direction. Accordingly, contact between the armature plate 86 and the friction disk 82 will be disengaged allowing the friction disk 82 to rotate freely.

In various embodiments, the manual brake release mechanism 18 can include a threaded sleeve, or bushing, 166 press fitted into a non-threaded, i.e., smooth bore, magnetic body center aperture 170. In such embodiments, the threads 118 mate with and engage the threaded sleeve 166. Therefore, angular rotation, or displacement, of the handle 110 about a center axis M of the brake release mechanism shaft 98 will axially, or linearly, move the shaft 98 along the M axis in the Y⁺ and Y⁻ directions, depending on the direction of angular rotation of the handle 110, as described above. The threaded sleeve 166 can be fabricated of any suitable material such as plastic, fiberglass, copper, steel, etc.

The manual brake release mechanism 18 can be accessible from any suitable location on the vehicle 10. For example, in various embodiments, the manual brake release mechanism 18 can be located under the seat 30 and can be accessed and operated by lifting the seat 30. However, the handle 110 of the manual brake release mechanism 18 can be accessible from any other suitable location on the vehicle 10 by including a suitable extension rod, device or mechanism between the distal end 114 of the shaft 98 and the handle 110.

Therefore, as described herein, the manual release mechanism 18 removes the force exerted on the armature plate 86 by the array of compression springs 90 by mechanically moving the armature plate in the Y⁻ direction. Therefore, the normal braking force and torque normally generated by the brake assembly 14 when power to the brake assembly is disabled or turned ‘Off’ can be removed to allow the vehicle to be towed or pushed.

The description herein is merely exemplary in nature and, thus, variations that do not depart from the gist of that which is described are intended to be within the scope of the teachings. Such variations are not to be regarded as a departure from the spirit and scope of the teachings.

What is claimed is:

1. A manual release mechanism for an electric braking assembly, said mechanism comprising a shaft having an armature retraction cap connected to a distal end of the shaft, a handle connected to an opposing proximal end of the shaft and threads formed along at least a portion of the shaft such that a small angular displacement of the handle will cause the retraction cap to exert force on an armature plate of the braking assembly to disengage contact between the armature plate and a friction disk of the braking assembly allowing the friction disk to rotate freely.

2. The mechanism of claim 1, wherein the threads comprise two or more independent threads helically formed along the shaft.

3. The mechanism of claim 1 further comprising a first stop sleeve positioned around the shaft at the proximal end for limiting axial travel of the shaft in a first direction.

4. The mechanism of claim 3 further comprising a second stop sleeve positioned around the shaft at the distal end for limiting axial travel of the shaft in a second direction opposite the first direction.

5. The mechanism of claim 4 further comprising a spring positioned around the first stop sleeve for providing rotational force to return the handle to, and hold the handle in, an idle position.

6. The mechanism of claim 1, wherein the armature retraction cap is integrally formed with the shaft distal end.

7. The mechanism of claim 1, wherein the retraction cap comprises a plate connected to the distal end of the shaft.

8. The mechanism of claim 1, further comprising a flanged annular cup positioned near the distal end of the shaft such that displacement of the handle will cause the retraction cap to exert force on the flanged annular cup and the flanged annular cup will exert a force on the an armature plate of the braking assembly to disengage contact between the armature plate and the friction disk of the braking assembly allowing the friction disk to rotate freely.

9. The mechanism of claim 1, wherein the angular displacement is approximately five to seven degrees.

10. An electric braking assembly comprising a magnetic body positioned adjacent an armature plate positioned between the magnetic body and a friction disk, and a manual release mechanism including a shaft extending through the magnet body, an armature plate retraction cap connected to a distal end of the shaft, a handle connected to a proximal end of the shaft, and threads formed along at least a portion of the shaft such that a small angular displacement of the handle will cause shaft to axially translate within the magnet body in a direction that will cause the retraction cap to exert force on an armature plate to disengage contact of the armature plate with the friction disk allowing the friction disk to rotate freely.

11. The assembly of claim 10, wherein the magnet body includes a threaded bore having threads that are mateable with the threads of the release mechanism.

12. The assembly of claim 10, wherein the release mechanism threads comprise two or more independent threads helically formed along the shaft.

13. The assembly of claim 10, wherein the release mechanism threads comprise non-locking type threads such that the release mechanism threaded shaft can self-return to a home position wherein contact between the armature plate and the friction disk is engaged resisting rotation of the friction disk.

14. The assembly of claim 10, wherein the manual release mechanism further comprises a first stop sleeve positioned around the release mechanism shaft at the proximal end for limiting axial travel of the release mechanism shaft in a first direction.

15. The assembly of claim 14, the manual release mechanism further comprises a torsion spring positioned around the first stop sleeve for providing rotational force to return the handle to, and hold the handle in, an idle position.

16. The assembly of claim 10, wherein the armature retraction cap is integrally formed with the release mechanism shaft distal end.

17. The mechanism of claim 10, wherein the retraction cap comprises a plate connected to the distal end of the release mechanism shaft.

18. The mechanism of claim 10, further comprising a flanged annular cup positioned near the distal end of the shaft such that displacement of the handle will cause the retraction cap to exert force on the flanged annular cup and the flanged annular cup will exert a force on the an armature plate of the braking assembly to disengage contact between the armature plate and a friction disk of the braking assembly allowing the friction disk to rotate freely

19. A light-weight vehicle power train comprising:
an electric motor having a shaft connected at a first end to a coupling of a gear reducer, and connected at a second end to an electric braking assembly, the braking assembly including:
a magnetic body positioned adjacent an armature plate positioned adjacent a friction disk; and
a manual release mechanism, the manual release mechanism including:
a shaft extending through the magnet body;
an armature plate retraction cap connected to a distal end of the shaft;
a handle connected to a proximal end of the shaft; and
threads formed along at least a portion of the shaft such that a small angular displacement of the handle will cause shaft to axial translate within the magnet body in a direction that will cause the retraction cap to exert force on an armature plate to disengage contact of the armature plate with the friction disk allowing the friction disk to rotate freely.

20. The power train of claim 19, wherein the release mechanism threads comprise two or more independent type threads helically formed along the shaft, the threads being non-locking such that the release mechanism threaded shaft can self-return to a home position wherein contact between the armature plate and the friction disk is engaged resisting rotation of the friction disk.

21. The power train of claim 19, wherein the release mechanism further comprises a spring positioned around the first stop sleeve for providing rotational force to return the handle to, and hold the handle in, an idle position.
